(19) United States
(12) Patent Application Publication
(10) Pub. No.: US 2007/0299703 A1
(43) Pub. Date: Dec. 27, 2007

(54) Method for the brokerage of benchmarks in healthcare pathways

(76) Inventors: Susanne Laumann, Nuremberg (DE); Martin Lang, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/474,881

(22) Filed: Jun. 26, 2006

(51) Int. Cl. G06Q 10/00; G06F 9/44

(52) U.S. Cl. 705/7; 705/2

(57) ABSTRACT

A method is provided for sharing healthcare benchmarks in which event data, status information, and measures from process instances of information systems of a local healthcare institution are monitored. The event data and measures are assigned into groups of process types and key measurements of the process instances into quality or performance indicators for each group of processes of a same type are aggregated, thereby creating combined process data. This combined process data of the local healthcare institution is provided to a globally accessible benchmark broker who stores the combined process data along with similarly processed combined process data other healthcare institutions. This data can be accessed by the local and other healthcare institutions. A user viewable comparison is produced between the combined process data of the local healthcare institution and the combined process data of the other healthcare institution.

### BACKGROUND

Currently healthcare institutions only very rarely measure their process capabilities systematically. Some associated professionals who participate in the relevant healthcare communities exchange some limited or loose measurements, such as “report turnover time”, among themselves, at conferences, or occasionally in publications.

Although some trendsetting customers have recognized the fact that having good internal processes are a competitive advantage for their businesses and increases the probability of surviving the consolidation trend and increased cost-pressures, what is lacking are possibilities to measure and compare process capabilities without having to utilize consultants (who are currently utilized for process capability benchmarking).

The following factors are lacking in the current situation: (a) a specific and timely knowledge about current processes. Modern healthcare institutions typically have only a relatively coarse granular knowledge about their current processes. They do not note or document a variety of existing versions of their standard processes, the variations of these standard processes (e.g., variations caused by exceptions, bottlenecks, etc.), and their frequency of occurrence for the processes or variants. Furthermore, variations related to continuous process changes (e.g., due to medical and technological progress) are rarely noted down and are untimely in the context of controlling processes; (b) a systematic, useful, business-supporting measurement-system of process capability; and (c) a brokerage system to compare and benchmark the measured parameters with other institutions.

The concept of Workflow-based Process Controlling is known from zur Muehlen, M. Workflow-based Process Controlling. Foundation, Design, and Implementation of Workflow-driven Process Information Systems. Logos, 2004, 6. This focuses on the ability to measure operational performance of business processes in a timely and accurate fashion by combining audit trails of Workflow-Engines with data warehouse technology and operational business data, allowing various complex analyses that can support managers in their assessment of an organization's performance.

### SUMMARY

The present invention relates to a method for sharing healthcare benchmarks, comprising: monitoring event data, status information, and measures from process instances of information systems of a local healthcare institution; assigning the event data and measures into groups of process types and aggregating key measurements of the process instances into quality or performance indicators for each group of processes of a same type, thereby creating combined process data; providing the combined process data of the local healthcare institution to a globally accessible benchmark broker; storing, by the benchmark broker, the combined process data of the local healthcare institution; storing, by the benchmark broker, similarly processed combined process data of another healthcare institution; accessing, by the local healthcare institution, the stored combined process data of the other healthcare institution; and producing user viewable comparison between the combined process data of the local healthcare institution and the combined process data of the other healthcare institution.

Accordingly, various embodiments of the invention provide for: a) reverse engineering of current process models that may encompass existing processes, versions and variations, and gathering “live” process knowledge to support process modeling; b) executive management support through a process capability measurement-system (content is IP); and c) engineer a service that allows a community to compare their process performance online, and, where available, to published standards.

Any institution that wishes to include process capability in its strategic goal can benefit from this solution, which may be implemented on a departmental level or at a whole institution level (e.g., all imaging centers). The information obtained will be primarily important for all senior roles, which contain managerial tasks. The set up and maintenance of the systems can be handled by both a supplier service staff as well as system administrators at an installed site.

Advantageously, customers can obtain a more detailed knowledge about their currently existing processes and can compare the process performance with their chosen peers. The peers can share best practices and learn from each other over time; thus, the performance of all group members will increase over time, resulting in a clear competitive advantage for the customers. Information gained can result in feedback that enhances product development and implementation.

The following use case explains an embodiment of the invention in operation for day by day work. An executive at a healthcare facility can access an online process capability chart, graphical information, report, or other summarizing display of information which compares the institution's performance with, e.g., standards (if any are available), the institution's own goals (if they are defined), and their peer's current performance. The information conveyed can be configurable to the community's needs, however, will ideally contain certain areas, including: a) parameters of medical quality assurance and healthcare pathways; b) parameters of general process capabilities; and c) financially relevant indicators.

The executive might also share best practice examples or explore exceptions with the other peers in the community. Any insights gained could be utilized for adapting in the institutions' processes or portfolio, resource management, or organizational development.

### DESCRIPTION OF THE DRAWINGS

Various embodiments of the present invention are described in more detail below with reference to the following drawing figures:

FIG. 1 is a block diagram/flow chart of an embodiment of the invention;

FIG. 2 is a block diagram of the RAA shown in FIG. 1;

FIG. 3 is a block diagram illustrating event and status information; and

FIG. 4 is a simplified pictorial diagram of the overall concept and sequence of actions.

### DETAILED DESCRIPTION OF THE PREFERRED EMBODIMENTS

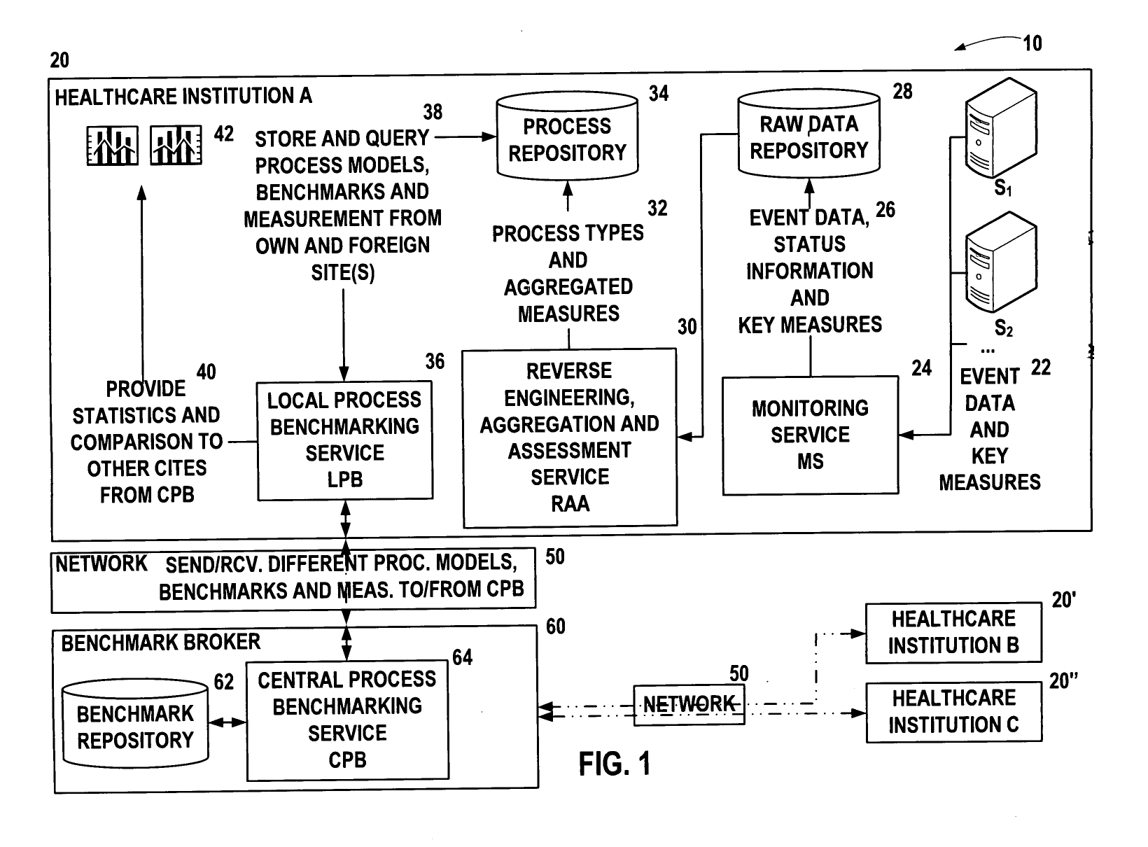

FIG. 1 illustrates an embodiment of the inventive system 10. In Healthcare Institution A 20 (which may be similar in structure to Healthcare Institutions B & C 20′, 20″ respectively), a Monitoring Service MS 24 is provided that collects event data, status information, and key measures 22 existing in the departmental information systems S₁, S₂, and other possible information systems (not shown). The Monitoring Service 24 monitors and gathers this information for each process instance, and deposits this event and status information 26 into a raw data repository 28.

The information contained within the raw data repository 28 is then utilized by a Reverse-Engineering Aggregation and Assessment Service (RAA) process 30 that reconstructs the process models out of the stored event and status information 26, using a process mining algorithm, as proposed by, e.g., C. W. Gunther and W. M. P. van der Aalst, Process Mining in Case Handling Systems, BETA Working Paper Series, WP 150, Eindhoven University of Technology, Eindhoven, 2005; W. M. P. van der Aalst and A. J. M. M. Weijters, Process Mining, in M. Dumas, W. M. P. van der Aalst, and A. H. M. ter Hofstede, editors, Process-Aware Information Systems: Bridging People and Software through Process Technology, pages 235-255. Wiley & Sons, 2005; and A. K. Alves de Medeiros, A. J. M. M. Weijters and W. M. P. van der Aalst, Genetic Process Mining: A Basic Approach and its Challenges, Workshop on Business Process Intelligence (BPI), Nancy, 2005, all herein incorporated by reference.

The RAA process 30 classifies process instances and groups, and assigns them to different groups of process types; it further aggregates the key measurements of the process instances to quality or performance indicators for each group of processes of the same type. This information is then placed in a local process repository 34.

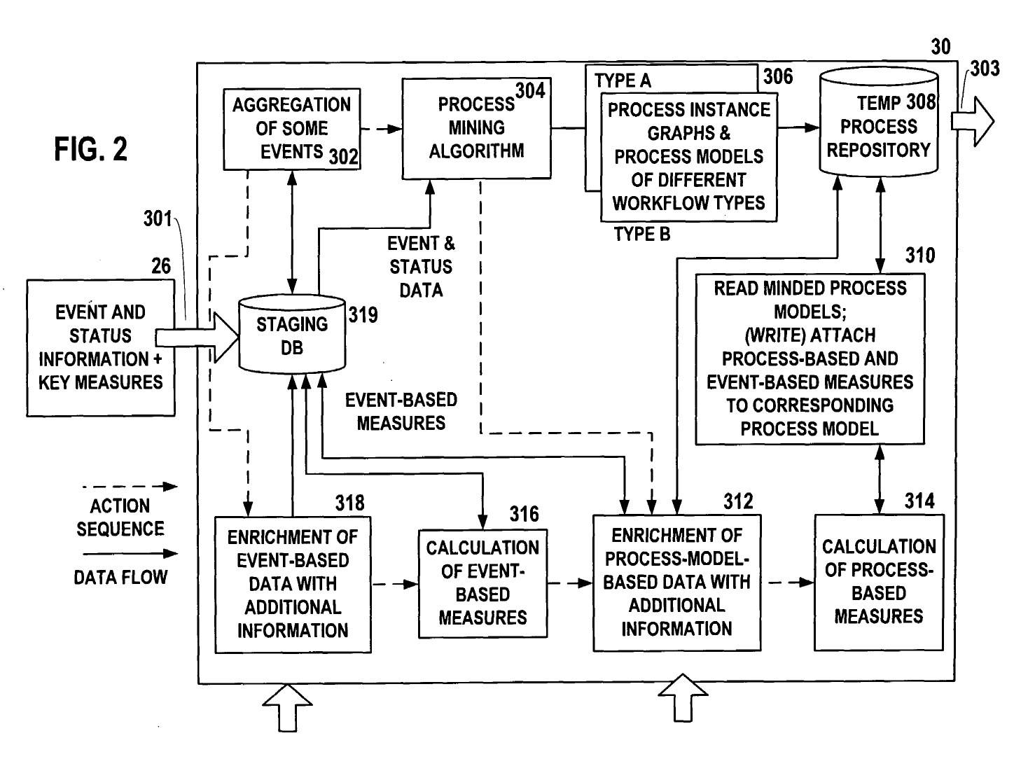

FIG. 2 provides a more detailed view of the RAA 30. The event data, status information and the key measures 26 are used as an input 301 for the RAA 30. Initially this input is stored in a staging database 319 which is accessed by various components 302, 304, 312, 316, 318 of the RAA 30.

The RAA 30 provides the process models for the different process types together with the corresponding instance graphs 306 of the process instances as an output 303. These models are enriched with a set of raw/computed and atomic/compound key measures/measurements 312. The process instance models are, in a process 312, enriched with the measurements for this particular process instance or case, and the reconstructed process types contain the aggregated measurements based on all process instances for this process type. As depicted FIG. 2, the operational sequence of the RAA 30 comprises the following actions/building blocks.
First, a module 302 is provided in which some events from the monitoring service 24 are aggregated (if necessary) to provide a homogeneous level of data/event granularity.
Next, in a process 318, raw event data is enriched with additional information like, e.g., an executing role and/or organizational unit, a hospital-wide patient identifier, personal costs, etc.
Afterwards, in a process 316, basic measures are calculated (e.g., the duration of a workflow task, based on its start and end timestamp or the costs for a task, using personal working timer per task and corresponding personal costs).

The process mining component 304 reconstructs the process models based on the pre-processed event data and stores the computed process models (the different process types) together with the corresponding process instance graphs in the temporary process repository 308. Different known process mining algorithms are available in current research literature, like, e.g., Alpha- or genetic mining algorithms (see references cited above).

As noted above, the process instance models are, in a process 312, enriched with the measurements for this particular process instance or case (e.g., from epr), and the reconstructed process types contain the aggregated measurements based on all process instances for this process type. A process 314 is provided for calculating process-based measures, and information is passed to a process 310 in which mined process models are read and process-based and event-based measures corresponding to a process model are attached/written to that process model, which further shares information with the temporary process repository 308.

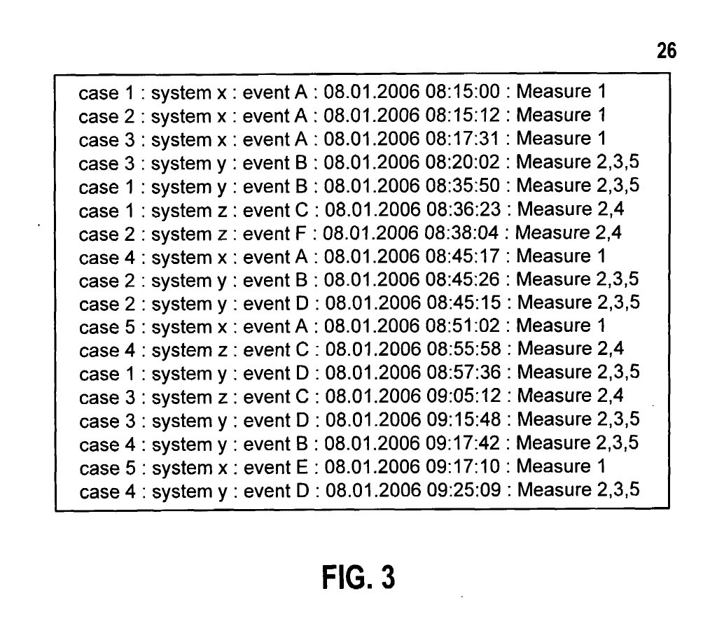

FIG. 3 provides an illustrated exemplary record format for the event and status information along with key measures. In the records shown, an event type is associated with a particular case and system, as well as appertaining measures—the records are time stamped with a date and time.

The information 32 from the process repository 34 may be accessed by a Local Process Benchmarking Service (LPB) 36, which communicates its own (Healthcare Institution A 20) assessed performance and quality key figures to a Central Process Benchmarking Service (CPB) 64, discussed below. In the same manner that the LPB 36 retrieves information 38 from the process repository 34 about its own institution 20, the LPB 36 also retrieves process benchmarks and measurements about other comparable healthcare institutions 20′, 20″ from the CPB 64. Access from the institutions 20, 20′, 20″ to the CPB 64 may be provided over any known network 50 utilizing any known networking technology and topology.

Additionally, the LPB 36 provides an analytical component that may be utilized to create a direct comparison of foreign (or external) and its own performance and quality aspects for selected process types (i.e., compare quality and performance of its own process types with the requested measures from other enterprises; detect differences/deviations in the processes; use data mining algorithms to find and classify interdependencies of measures and specific classes of processes, process partitions or process courses regarding measures and process knowledge from different sites), and may provide the statistics and comparisons 40 to users in the form of graphs, charts, reports, etc. 42.

The Central Process Benchmarking Service (CPB) 64 may be a part of a common benchmark broker 60 who, in addition to providing the CPB service 64 via which information is written to or read, also comprises a globally accessible benchmark repository 62 into which the benchmarking data is stored and from which this data is retrieved. The CPB service 64 may also be used to deal with customer registration issues and can be utilized to provide customized access depending upon various registration classifications.

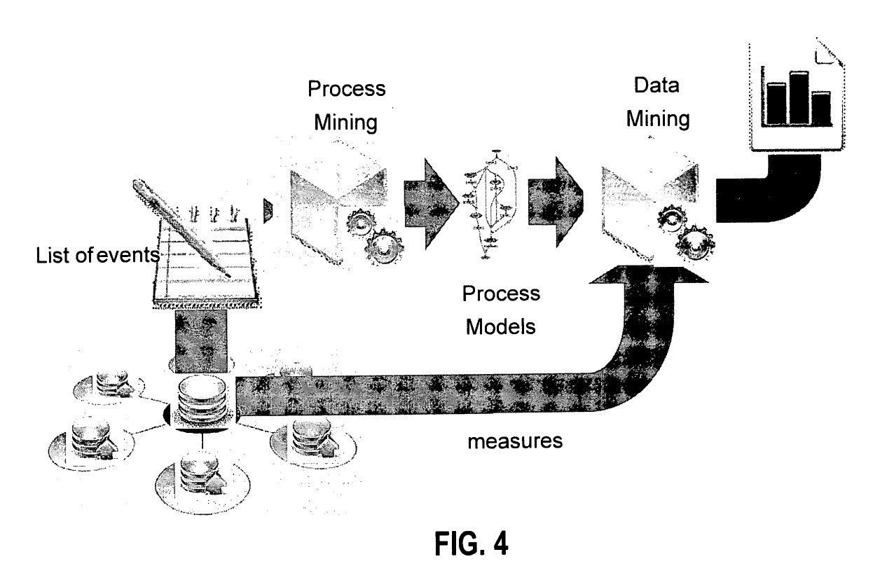

FIG. 4 shows a simplified pictorial diagram in which information flowing from various centers comprises either a list of events that are used for the process mining that produces process models or the precalculated process models itself. Additionally various process related measures are obtained from the centers that are used by the data mining procedure (which also utilizes information from the process models), in order to detect dependencies (e.g. between measures and process courses, process types or process partitions), to detect trends and continous process changes and to produce various charts, graphs, etc. related to benchmarks and other statistical information.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for sharing healthcare benchmarks, comprising:
monitoring event data, status information, and measures from process instances of information systems of a local healthcare institution;
assigning the event data and measures into groups of process types and aggregating key measurements of the process instances into quality or performance indicators for each group of processes of a same type, thereby creating combined process data;
providing the combined process data of the local healthcare institution to a globally accessible benchmark broker;
storing, by the benchmark broker, the combined process data of the local healthcare institution;
storing, by the benchmark broker, similarly processed combined process data of another healthcare institution;
accessing, by the local healthcare institution, the stored combined process data of the other healthcare institution; and
producing a user viewable comparison between the combined process data of the local healthcare institution and the combined process data of the other healthcare institution.

2. The method according to claim 1, wherein the comparison is provided in a form selected from the group consisting of a chart, a graph, and a report.

3. The method according to claim 1, wherein the monitored data is stored in a raw data repository.

4. The method according to claim 1, wherein the assigning comprises implementing reverse engineering of existing process models in a reverse engineering, aggregation and assessment service (RAA).

5. The method according to claim 4, further comprising:
inputting the event data and measures at an input of the RAA;
enriching process models with the input event data and measures by the RAA; and
outputting the enriched process models by the RAA.

6. The method according to claim 5, further comprising enriching the process models with additional information.

7. The method according to claim 6, wherein the additional information is selected from the group consisting of executing role, organizational unit, and hospital-wide patient identifier.

8. The method according to claim 5, further comprising:
utilizing a process mining component for reconstructing process models based on pre-processed event data and storing computed process models together with corresponding process instance graphs in a temporary process repository.

9. The method according to claim 8, wherein the process mining component utilized an algorithm selected from the group consisting of an alpha mining algorithm and a genetic mining algorithm.

10. The method according to claim 4, wherein the RAA aggregates events from the monitoring service to provide a homogeneous level of data or event granularity.

11. The method according to claim 4, further comprising enriching the process models with additional information and subsequently calculating basic measures.

12. The method according to claim 11, wherein the basic measures are selected from the group consisting of: a) duration of a workflow task based on its start and end timestamp, and b) costs for a task, based on a personal working timer per task and corresponding personal costs.

13. The method according to claim 1, wherein the combined process data comprises parameters of medical quality assurance and healthcare pathways, parameters of general process capabilities, and financially relevant indicators.

14. The method according to claim 1, wherein the event data and measures comprise identifiers related to case, system, event, and measures.

15. The method according to claim 14, wherein the event data further comprises a timestamp.

16. The method according to claim 1, further comprising:
detecting at least one of differences and deviations in the processes; and
providing a representation of these detected aspects as a part of the viewable comparison.

17. The method according to claim 1, further comprising:
finding and classifying, with data mining algorithms, interdependencies of measures and specific classes of processes, process partitions or process courses regarding measures and process knowledge from different sites.

18. The method according to claim 1, further comprising:
detecting at least one of dependencies, trends, and continuous process changes from process-related measures obtained from the other healthcare institution; and
producing a user-viewable chart, graph, or other displayed output related to statistical information.
